(19) United States
(12) Patent Application Publication
(10) Pub. No.: US 2006/0078154 A1
(43) Pub. Date: Apr. 13, 2006

(54) Electricalacoustic ransducer

(76) Inventor: Ho-joon Yang, Gumi (KR)

Correspondence Address: KOPPEL & JACOBS, Suite 215, 2151 Alessandro Drive, Ventura, CA, 93001, US

(21) Appl. No.: 11/245,676

(22) Filed: Oct. 7, 2005

(30) Foreign Application Priority Data
Oct. 11, 2004 (KR) 10-2004-0080804
Nov. 19, 2004 (KR) 10-2004-0095036

(51) Int. Cl. H04R 1/00

(52) U.S. Cl. 381/423; 381/397; 381/424

(57) ABSTRACT

Disclosed is an electrical acoustic transducer applied to speakers, earphones, headphones, etc. The electrical acoustic transducer includes a frame having a cone, a voice coil provided on a lower end of the cone, a yoke and a permanent magnet that are provided on a lower end of the frame, a cap provided in the middle of the cone, a vent hole formed in the middle of the cap, and a resonance unit formed as a slot in the center of the yoke. The slot of the resonance unit is opposite to the vent hole. With the electrical acoustic transducer, drastic vibration of the cone is relieved by the resonance unit as well as the vent hole formed in the domed or flat cap, and thus a harsh sound is relieved. After being assembled, each speaker exerts its inherent performance to the maximum extent, so that it is possible to hear a clear and sweet sound.

### BACKGROUND OF THE INVENTION

1. Field of the Invention

The present invention relates to an electrical acoustic transducer applied to speakers, earphones, headphones, and so on, and more specifically, to an electrical acoustic transducer with improved responsiveness and performance that reproduces high-quality clear sound.

2. Description of the Related Art

In general, a speaker is configured as shown in FIG. 1. A frame 1 is provided with a cone 2. A voice coil 4 is assembled on a lower end of the cone 2. A domed cap 3 is mounted in the center of the cone 3. A yoke 6 and a permanent magnet 5 are assembled on a lower end of the frame 1.

Further, a speaker system has a configuration shown in FIG. 2, where three speakers are installed in a resonance box 10 to reproduce high-, middle-, and low-frequency sound.

It is fundamental that the speakers must be configured in a system in order to produce a full acoustic effect. Speaker systems can have various configurations. For instance, one resonance box may house one, two, or more speakers. The following description assumes the most common case of a speaker system having three speakers installed in one resonance box, as an example.

In such a speaker system, electrical signals are supplied from the outside (not shown), causing cones 2 to vibrate back and forth to generate sound. When the cones 2 move backward, negative pressure is generated in the resonance box 10, and when the cones 2 move forward, positive pressure is generated in the resonance box 10. This dampens the vibration of the cones 2. For this reason, a ventilation hole called a damper 11 is installed in the resonance box 10 to allow air to flow in and out of the resonance box as indicated by arrows in FIG. 2 and thus relieve pressure and allow the cones 2 to vibrate smoothly. However, the responsiveness and performance of the speaker system deteriorate leading to eventual failure to reproduce clear sound.

An example of a method for solving this problem is disclosed in U.S. Pat. No. 5,844,998. The disclosed method uses a structure having an acoustic equalizer in order to improve a frequency characteristic. However, the speaker system itself does not have a vent hole. Thus, a ventilator called a damper is installed at an appropriate position of a resonance box to relieve pressure generated when a speaker's cone vibrates back and forth. As such, the speaker system has low acoustic responsiveness and performance and fails to reproduce high-quality clear sound.

Further, in conventional headphones or earphones, a vibration plate cannot vibrate smoothly, which deteriorates sound quality. Various efforts have been made to solve this problem, some involving varying the material of the vibration plate, however the fundamental problem of a vibration mode of a voice coil cannot been solved.

### SUMMARY OF THE INVENTION

It is, therefore, an objective of the present invention to provide an electrical acoustic transducer, in which a vent hole is provided to make a resonance box act as an air spring and to properly damp sharp vibration of a cone, thereby relaxing a harsh sound.

It is another objective of the present invention to provide an electrical acoustic transducer capable of enhancing resonant effects in cooperation with a resonance box and improving responsiveness and performance by using a vent hole to thus reproduce high-quality clear sound.

In order to accomplish the objectives of the present invention, there is provided an electrical acoustic transducer that include a frame having a cone, a voice coil provided on a lower end of the cone, a yoke and a permanent magnet that are provided on a lower end of the frame, a cap provided in the middle of the cone, and a vent hole formed in the middle of the cap.

The electrical acoustic transducer may further include a resonance unit formed as a slot in the center of the yoke. Here, the slot of the resonance unit may be opposite to the vent hole.

Further, the cap may have a flat shape.

In addition, the cap may have a domed shape.

The electrical acoustic transducer may be an earphone.

Further, the electrical acoustic transducer may be a headphone.

Further, the electrical acoustic transducer may be a speaker.

The speaker may be provided in a resonance box in plural numbers.

The plurality of speakers may be used for high-, middle-, and low-frequency sound, respectively.

Further, partitions for closure may be provided between the speakers for high-, middle-, and low-frequency sound to define the resonance boxes that resonate corresponding to the respective speakers.

The resonance boxes defined by the partitions for closure may be provided with dampers, respectively

The vent hole may have a substantially circular shape.

Further, the vent hole may have a diameter of about 1/50 of that of the cap.

The yoke may include a vertical section formed with the slot and a horizontal section integrally formed with the vertical section, and the vertical section may have a thickness that is substantially equal to that of the horizontal section.

Further, the slot may have a bottom that is formed not to exceed the horizontal section.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a side cross-sectional view of a conventional speaker;

FIG. 2 is a side cross-sectional view of a conventional speaker system;

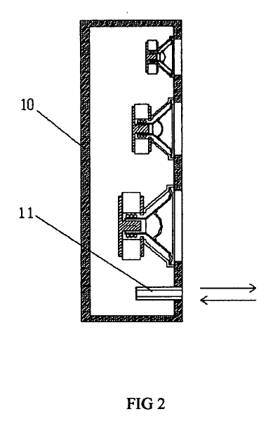

FIG. 3 is a side cross-sectional view of a speaker according to a first embodiment of the present invention;

FIG. 4 is a side cross-sectional view of a speaker system according to a second embodiment of the present invention;

FIG. 5 is a side cross-sectional view of a speaker system according to a third embodiment of the present invention;

FIG. 6 is a side cross-sectional view of an earphone unit according to a fourth embodiment of the present invention;

FIG. 7 is a side cross-sectional view of a headphone unit according to a fifth embodiment of the present invention;

FIG. 8 is a side cross-sectional view of a mounted headphone or earphone unit according to a sixth embodiment of the present invention;

FIG. 9 is a side cross-sectional view of a headphone unit, in which an headphone assembled to its case is mounted to a head in accordance with the sixth embodiment of the present invention; and

FIG. 10 is a side cross-sectional view of an earphone unit, in which an earphone assembled to its case is mounted to a head in accordance with the sixth embodiment of the present invention.

### DETAILED DESCRIPTION OF THE INVENTION

Hereinafter, exemplary embodiments of the present invention will be described in more detail with reference to the accompanying drawings.

Further, in the description of the present invention, like reference symbols indicate the same or similar components. Thus, their repeated descriptions will be omitted.

### FIRST EMBODIMENT

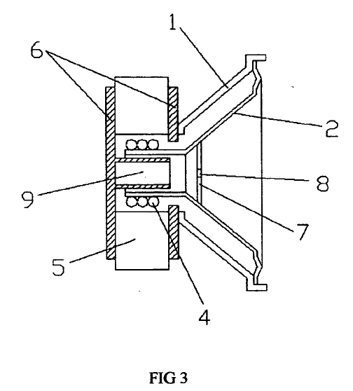

FIG. 3 is a side cross-sectional view of a speaker according to a first embodiment of the present invention.

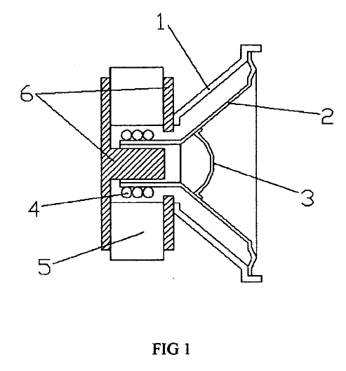

As the basic configuration of the speaker shown in FIG. 3, a frame 1 is provided with a cone 2. A voice coil 4 is assembled on a lower end of the cone 2, and a flat cap 7 is mounted in the middle of the cone 2. The present invention is not limited to the flat cap 7 as shown in FIG. 3, but may make use of a domed cap as shown in FIG. 1.

It is one of main features of the present invention that a vent hole 8 is formed in the middle of the domed or flat cap 7. It is another feature that a blind slot is formed in the middle of a yoke 6 which is located on a lower end of the frame 1, thereby acting as a resonance unit 9. Then, the yoke 6 having the resonance unit 9 is assembled with a permanent magnet 5.

Further, the slot of the resonance unit 9 is opposite to the vent hole 8.

The vent hole 8 is substantially circular in shape, whose diameter is about 1/50 of that of the cap. When the diameter of the vent hole 8 is less or more than 1/50 of that of the cap, the quality of sound is deteriorated.

Further, the yoke 6 consists of a vertical section having a slot and a horizontal section integrally formed with the vertical section. The vertical section is formed to a thickness that is substantially equal to that of the horizontal section. A bottom of the slot is formed not to exceed the horizontal section.

In this manner, the reason restricting the thickness and depth of the slot formed in the yoke 6 is for preventing distortion from being generated due to a narrow passage of a magnetic circuit formed by the permanent magnet 5 and the yoke 6.

### SECOND EMBODIMENT

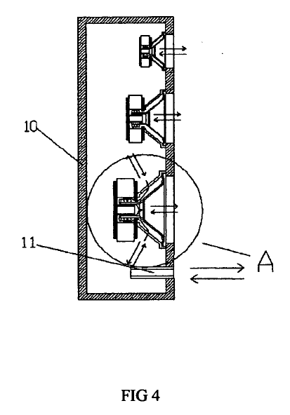

FIG. 4 is a side cross-sectional view of a speaker system according to a second embodiment of the present invention.

In FIG. 4, speakers for high-, middle-, and low-frequency sound are installed as one constituent, and cones 2 vibrate back and forth by receiving electrical signals from the outside (not shown). When the cones 2 move backward, negative pressure is generated in a resonance box 10 to thus hinder the vibration of the cones 2. In contrast, when the cones 2 move forward, positive pressure is generated in the resonance box 10 to thus hinder the vibration of the cones 2. However, as set forth in the first embodiment, the present invention employs a structure in which the flat or domed cap 7 is formed with a vent hole 8 and the resonance box 10 is provided with a damper 11.

In this manner, with the vent hole 8, the pressure generated by the closure of the resonance box 10 is processed by the damper 11, and simultaneously each speaker effectively deals with the generated negative or positive pressure in arrow directions through the vent hole 8 provided to each speaker at once. Thus, responsiveness and performance of the sound are improved.

To be more specific about airflow around each speaker, in the portion A indicated by a circle, the airflow is made in the arrow directions. The arrow directions change depending on the vibrating direction of the cone 2, and thus the air is sucked or discharged. Then, the remaining negative or positive pressure is processed by the damper 11, thereby improving the responsiveness and performance.

Further, in the second embodiment, because each of the speakers is provided with an additional resonance unit 9 which acts as an air spring to damp the vibration of the cone 2, a harsh sound caused by the vibration of the cone 2 is relaxed and resonant effects are multiplied.

### THIRD EMBODIMENT

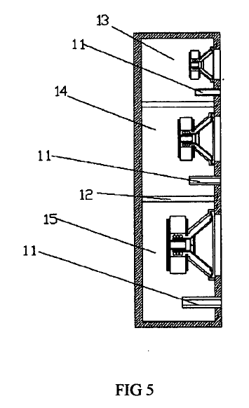

FIG. 5 is a side cross-sectional view of a speaker system according to a third embodiment of the present invention.

Each speaker of the speaker system shown in FIG. 5 performs the same function as that of the speaker system shown in FIG. 4. However, the speaker system shown in FIG. 5 is configured so that a partition 12 is provided between the speakers to define resonance boxes 13, 14 and 15 in a closed state, and each of the resonance boxes 13, 14 and 15 is provided with a damper 11 to allow each speaker to resonate according to its own characteristic.

In other words, the three speakers are used for high-, middle-, and low-frequency sound, between two of which the partitions 12 for closure are each provided to define the resonance boxes 13, 14 and 15. The resonance boxes 13, 14 and 15 resonate corresponding to the speakers respectively, and are provided with the dampers 11, 11 and 11, respectively.

### FOURTH EMBODIMENT

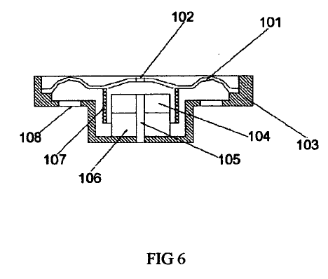

FIG. 6 is a side cross-sectional view of an earphone unit according to a fourth embodiment of the present invention.

Specifically, FIG. 6 is a side cross-sectional view of an earphone unit to which a vibration plate with a vent hole 102 is mounted. In the earphone unit, a yoke 104 and a permanent magnet 106 are mounted in a body 103 and fixed to the body 103 by a hollow rivet 105, and the vibration plate 101 provided with a voice coil 107 is assembled on an upper portion of the body 103 formed with a ventilating section 108.

Like the first embodiment, in the fourth embodiment, the vibration plate 101 is provided with the vent hole 102, so that a bottom of the hollow rivet 105 is closed to form a resonance unit as in FIG. 3.

### FIFTH EMBODIMENT

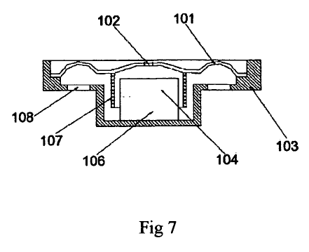

FIG. 7 is a side cross-sectional view of a headphone unit according to a fifth embodiment of the present invention.

Specifically, FIG. 7 is a side cross-sectional view of a headphone unit to which a flat vibration plate with a vent hole 102 is mounted. In the headphone unit, a yoke 104 and a permanent magnet 106 are mounted in a body 103 and fixed to the body 103 by an adhesive, and the vibration plate 101 provided with a voice coil 107 is assembled on an upper portion of the body 103 formed with a ventilating unit 108.

Like the first embodiment, in the fifth embodiment, the vibration plate 101 is provided with the vent hole 102, so that a bottom of the body 103 closes the middle portions of the yoke 104 and permanent magnet 106 to form a resonance unit as in FIG. 3.

### SIXTH EMBODIMENT

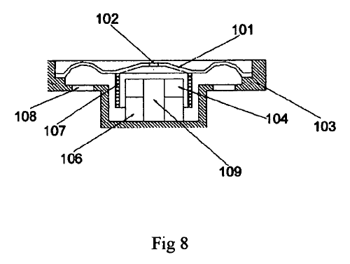

FIG. 8 is a side cross-sectional view of an earphone or headphone unit according to a sixth embodiment of the present invention.

Specifically, FIG. 8 is a side cross-sectional view of an earphone or headphone unit to which a vibration plate 101 with a vent hole 102 is mounted. In the headphone unit, a yoke 104 and a permanent magnet 106 are mounted in a body 103 and fixed to the body 103 by an adhesive, and the vibration plate 101 provided with a voice coil 107 is assembled on an upper portion of the body 103 formed with a ventilating unit 108.

Like the first embodiment, in the sixth embodiment, the vibration plate 101 is provided with the vent hole 102, and the middle portions of the yoke 104 and permanent magnet 106 is provided with a through-slot, so that a bottom of the body 103 closes the through-slots of the middle portions of the yoke 104 and permanent magnet 106 to form a resonance unit 109 provided with the slot.

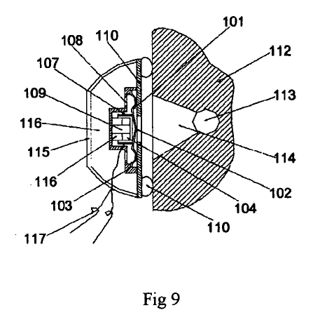

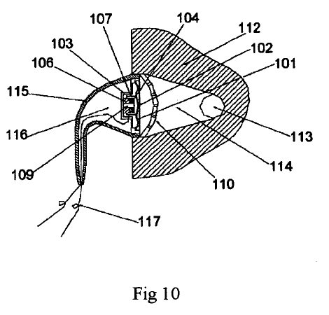

Next, the headphone and earphone which are mounted to a head in accordance with the sixth embodiment will be described with reference to FIGS. 9 and 10.

FIG. 9 is a side cross-sectional view of a headphone unit, in which an headphone assembled to its case is mounted to a head in accordance with the sixth embodiment of the present invention, and FIG. 10 is a side cross-sectional view of an earphone unit, in which an earphone assembled to its case is mounted to a head in accordance with the sixth embodiment of the present invention.

In FIG. 9, the headphone unit where a headphone assembled to its case is mounted to a head is viewed as an assembly on the whole. Reference numbers of FIG. 9 indicate as follows: 101 for a vibration plate, 102 for a vent hole, 103 for a body, 104 for a yoke, 106 for a permanent magnet, 107 for a voice coil, 108 for a ventilating unit, 109 for a resonance unit, 110 for a front cover, 111 for a close contact, 112 for a head, 113 for an eardrum, 114 for an ear hole, 115 for a rear cover, 116 for a resonance box, and 117 for a connection line. The headphone is mounted to the head 112.

As shown in FIG. 9, the close contact 111 and the head 112 are brought into close contact with each other, so that the ear hole 114 becomes a closed space. When the vibration plate 101 vibrates to be pushed forward, air in the ear hole 114 is pressured to cause the vibration plate 101 to be pushed backward. Then, internal air of the rear cover 115 is subjected to vacuum pressure (positive pressure), so that the action pulling the vibration plate 101 occurs to prevent the vibration from being freely generated. In the reverse case, the same result is generated. However, according to the present invention, the middle portion of the vibration plate 101 is provided with the vent hole 102, so that the negative pressure is reduced through the vent hole 102, while the vacuum pressure forces the air of the front portion to be sucked through the vent hole 102. Thereby, the air pressure maintains atmospheric pressure at all times. Accordingly, the vibration of the vibration plate 101 is freely made, and two resonating parts of the resonance unit 109 and the resonance box 116 are provided in the headphone unit and the case respectively, so that it is possible to obtain an excellent stereophonic sound.

Further, FIG. 10 shows an example of applying the headphone of FIG. 9 to an earphone, and is a side cross-section view of an earphone unit and its case in which an earphone having a flat vibration plate 102 formed with a vent hole 102 is mounted to a head.

In the assembly shown in FIG. 10, when an earphone is fitted into an ear hole 114, the action as shown in FIG. 9 occurs to have the same effect as in FIG. 9.

Although the preferred embodiments and drawings of the present invention have been disclosed for illustrative purposes, those skilled in the art appreciate that various substitutions, modifications, changes and additions are possible, without departing from the scope and spirit of the invention as disclosed in the accompanying claims.

As set forth above, according to the electrical acoustic transducer of the present invention, drastic vibration of the cone is relieved by the resonance unit as well as the vent hole formed in the domed or flat cap, and thus harsh sound is relieved. After being assembled, each speaker exerts its inherent performance to the maximum extent, so that it is possible to hear high-quality clear sound.

Further, the vent hole of the vibration plate and the resonance unit allow the vibration plate to freely vibrate and completely realize resonating action, so that it is possible to reproduce excellent stereophonic sound.

What is claimed is:

1. An electrical acoustic transducer of transducing an electrical signal into a sound signal, comprising:
a frame having a cone;
a voice coil provided on a lower end of the cone;
a yoke and a permanent magnet that are provided on a lower end of the frame;
a cap provided in the middle of the cone; and
a vent hole formed in the middle of the cap.

2. The electrical acoustic transducer according to claim 1, further comprising a resonance unit formed as a slot in the center of the yoke,
wherein the slot of the resonance unit is opposite to the vent hole.

3. The electrical acoustic transducer according to claim 1 or 2, wherein the cap has a flat shape.

4. The electrical acoustic transducer according to claim 1 or 2, wherein the cap has a domed shape.

5. The electrical acoustic transducer according to claim 1 or 2, being an earphone.

6. The electrical acoustic transducer according to claim 1 or 2, being a headphone.

7. The electrical acoustic transducer according to claim 1 or 2, being a speaker.

8. The electrical acoustic transducer according to claim 7, wherein the speaker is provided in a resonance box in plural numbers.

9. The electrical acoustic transducer according to claim 8, wherein the plurality of speakers are used for high-, middle-, and low-frequency sound, respectively.

10. The electrical acoustic transducer according to claim 9, wherein partitions for closure are provided between the speakers for high-, middle-, and low-frequency sound to define the resonance boxes that resonate corresponding to the respective speakers.

11. The electrical acoustic transducer according to claim 10, wherein the resonance boxes defined by the partitions for closure are provided with dampers, respectively.

12. The electrical acoustic transducer according to claim 1, wherein the vent hole has a substantially circular shape.

13. The electrical acoustic transducer according to claim 12, wherein the vent hole has a diameter of about 1/50 of that of the cap.

14. The electrical acoustic transducer according to claim 2,
wherein the yoke includes a vertical section formed with the slot and a horizontal section integrally formed with the vertical section, and
wherein the vertical section has a thickness that is substantially equal to that of the horizontal section.

15. The electrical acoustic transducer according to claim 14, wherein the slot has a bottom that is formed not to exceed the horizontal section.
